(19) United States
(12) Patent Application Publication
(10) Pub. No.: US 2022/0402597 A1
(43) Pub. Date: Dec. 22, 2022

(54) APPARATUS, ASSEMBLY AND METHOD FOR CONTROLLING AN ACTUATING SYSTEM OF AN AIRCRAFT IN AN OPEN-LOOP AND CLOSED-LOOP MANNER

(71) Applicant: TECHNISCHE UNIVERSITÄT BERLIN, Berlin (DE)

(72) Inventor: Wolfram MEYER-BRÜGEL, Berlin (DE)

(73) Assignee: TECHNISCHE UNIVERSITÄT BERLIN, Berlin (DE)

(21) Appl. No.: 17/777,675

(22) PCT Filed: Nov. 19, 2020
(86) PCT No.: PCT/DE2020/100980

§ 371 Date: May 18, 2022

(30) Foreign Application Priority Data
Nov. 19, 2019 (DE) 10 2019 008 153.6

(51) Int. Cl. B64C 13/50

(52) U.S. Cl. CPC B64C 13/503

(57) ABSTRACT

A device for control and closed-loop control of an actuating system of an aircraft is disclosed. The device has a first input interface, which is configured to receive first input data indicating a reference variable, a second input interface, which is configured to receive second input data indicating a controlled variable, and a control output, which is configured to output a control signal. The control signal indicates a manipulated variable for an actuating system of an aircraft, which is to be controlled by means of the actuating system. The reference variable indicates a target acceleration at a point of the aircraft that is to be controlled by means of the actuating system, and the controlled variable indicates an actual acceleration of the aircraft at the point. Taking into account the reference variable and the controlled variable, the device is configured to determine the manipulated variable, in particular from the difference between the reference variable and the controlled variable, and to output the control signal corresponding to the manipulated variable via the control output. Further, an arrangement for control and closed-loop control of an actuating system of an aircraft as well as a method are provided.

The invention relates to a device, an arrangement, and a method for control and closed-loop control of an actuating system of an aircraft.

### BACKGROUND

Actuating systems of an aircraft, for example, include flight control surface assemblies, such as elevators, rudders and ailerons, with actuators allocated to flight control surfaces for moving said flight control surfaces, as well as nozzles, propellers, buoyancy aids such as flaps, spoilers and lateral force controls.

A cascade control is traditionally used for the actuating systems of aircraft. In an outer control loop, the flight control, a reference variable for controlling an actuator controlling a respective degree of freedom of the aircraft is determined as the manipulated variable of the flight control from state variables of the aircraft in relation to the degree of freedom to be controlled. In the case of a pitch control, the reference variable for the actuator control is an actuator deflection, and hence a deflection of the elevator. Herein, the elevator is usually moved by means of an actuator, for example a translatory, hydraulic or rotary electromagnetic actuator, so that the reference variable corresponds to a target rotational position of the actuator. The actuator control with the reference variable as the input variable forms an inner control loop. In the case of a rotary electromagnetic actuator for moving a flight control surface, in particular a so-called servocontrol is involved, in which a rotational speed (positioning speed) of the actuator serves as the controlled variable of an inner control loop, wherein a corresponding reference variable (target rotational speed) of the inner control loop is determined from the target rotational position. An actuator current for operating the actuator is determined from the control deviation of the inner control loop, i.e., the difference between the target rotational speed and the actual rotational speed of the actuator. In addition, another inner control loop can be provided, in which the actuator current is the controlled variable, and the manipulated variable is an actuator voltage. A positioning acceleration of the actuator can be considered for the servocontrol. A measurement of accelerations can be provided in the flight control for observation purposes, or as a replacement for poorly measurable states.

As a rule, the servocontrol has a considerably faster dynamic by comparison to the flight control, so that the flight control limits the overall dynamic of the control system. However, against the backdrop of the rapidly increasing expansion and importance of unmanned and/or autonomously operating flying objects, new areas of application are arising for flight control technologies, which require a highly dynamic control of flight dynamics. In addition to a precise path guidance on complex trajectories, numerous measurement and observation tasks require an elevated positional stability and flight smoothness. Furthermore, there is a discernible trend in aircraft development toward more efficient, aerodynamically high-quality configurations, which are distinguished by high wing stretch and span. In particular in conjunction with increasingly larger, lightweight, and thus elastic structures and assemblies, which require a reduction in structural loads by control technology and an active stabilization of the comparatively low-frequency structural dynamic modes, eigenfrequencies can exceed the dynamics of the known regulation systems.

As opposed to known positional control (actuator deflection as the reference variable), document DE 10 2016 117 634 A1 proposes a conversion to a force/torque-controlled approach. For this purpose, each actuator is provided with a force/torque controller, with which the actuator is controlled based on the allocated reference variable, specifically a target force, a target force change, a target torque or a target torque change, and a controlled variable, specifically a force generated by the actuator or a torque generated by the actuator. The controlled variable is herein determined by a sensor device, which is respectively present on or in the actuator, or in the drivetrain of the respective actuator. The controlled variable, i.e., the drive torque in the case of a flight control surface assembly, is thus measured on the mechanical transmission path between the generated force in the actuator and the flight control surface. This drive torque produces a rotational acceleration of the flight control surface relative to the aircraft. At the same time, the air forces exert an aerodynamic rudder hinge torque on the flight control surface. In the quasi-stationary state, an equilibrium exists between the drive torque and aerodynamic rudder hinge torque, so that the reference variable corresponds to the rudder hinge torque in this case. As a consequence, the force control causes the control surfaces to react “flexibly” or “elastically” to gust loads externally applied to the control surface. According to the approach proposed in document DE 10 2016 117 634 A1, a feedback proportional to the deflection of the flight control surface is not relied upon. This limits a configuration of system dynamics compared to a complete state vector feedback.

For such a force/torque-controlled system, document DE 10 2016 117 638 A1 discloses that the influence of a gust on the aircraft may be minimized by correspondingly over- or undercompensating the hinge torque. Herein, the force/torque component produced by a gust is determined, and the target value for the control force/control torque is modified depending on the influence of the gust on the hinge torque of the control surface. An additional speed-proportional damping term is intended to reduce the vibration tendency of the natural rudder angle dynamics (rudder flutter). In one configuration, the actuator position (actuator deflection) and positioning speed can be fed back, this taking place not in the form of a cascade, but as direct feedbacks that are independent of each other.

### Abstract

The object of the invention is to provide new technologies for control and closed-loop control, i.e. controlling and regulating, an actuating system of an aircraft, which in particular permit a rapid and precise control while considering various factors influencing the flight behavior.

For achieving the object, a device for control and closed-loop control of an actuating system of an aircraft according to the independent claim 1 as well as an arrangement and a method for control and closed-loop control of an actuating system of an aircraft according to further claims are provided.

According to one aspect, a device for control and closed-loop control of an actuating system of an aircraft is provided. The device is provided with a first input interface, which is configured to receive first input data indicating a reference variable, a second input interface, which is configured to receive second input data indicating a controlled variable, and a control output, which is configured to output a control signal that indicates a manipulated variable for an actuating system of an aircraft, which is to be controlled by means of the actuating system. The reference variable indicates a target acceleration at a point of the aircraft that is to be controlled by means of the actuating system, and the controlled variable indicates an actual acceleration of the aircraft at the point. Taking into account the reference variable and the controlled variable, the device is configured to determine the manipulated variable, in particular from the difference between the reference variable and the controlled variable, and output the control signal corresponding to the manipulated variable via the control output.

According to a further aspect, an arrangement for control and closed-loop control of an actuating system of an aircraft is provided. The arrangement comprises an aircraft, a flight control device with an output interface and a device for control and closed-loop control of an actuating system of an aircraft as disclosed herein. The aircraft has an actuating system that is configured to control the aircraft in at least one degree of freedom, and an acceleration sensor that is arranged on a point of the aircraft. Based upon a flight status of the aircraft, the flight control device is configured to calculate the reference variable that indicates a target acceleration at the point of the aircraft, and to transmit the first input data indicating the reference variable to the first input interface of the device via the output interface. The acceleration sensor is configured to measure the local acceleration of the aircraft at the point, and to transmit the second input data indicating the controlled variable to the second input interface of the device, which indicate the local acceleration at the point. The actuating system is configured to receive the manipulated variable from the control output of the device, and to perform a positioning movement corresponding to the manipulated variable.

According to yet another aspect, a method for control and closed-loop control of an actuating system of an aircraft is provided. The method comprises the steps of providing a device for control and closed-loop control of an actuating system of an aircraft, generating first input data indicating a reference variable, wherein the reference variable indicates a target acceleration at a point of the vehicle that is to be controlled by means of the actuating system, generating second input data indicating a controlled variable, wherein the controlled variable indicates an actual acceleration of the vehicle at the point, receiving the first input data at a first input interface of the device, receiving the second input data at a second input interface of the device, determining a manipulated variable for an actuating system of the aircraft taking into account the reference variable and the controlled variable, in particular from the difference between the reference value and the controlled variable, and outputting a control signal indicating the manipulated variable via a control output of the device.

For example, the actuating system can be a flight control surface assembly and an actuator for operating the flight control surface. Herein, the actuator can be the system for generating an actuating force or an actuating torque without an accompanying control system. Alternatively, the actuator can have a control, in particular a servocontrol. The flight control surface assembly can comprise a fixed part (buoyancy surface), i.e. an immovable part relative to the aircraft, and a movable flight control surface, which depending on its position relative to the fixed part exerts a desired control effect on the aircraft. The actuator can be a rotary electromagnetic actuator, meaning for example an electromotor, which rotates the flight control surface relative to the fixed part of the assembly. The flight control surface assembly can be an elevator, rudder, or aileron. Alternatively, for example, the actuating system can be a flap for controlling the lift of the aircraft, a spoiler for longitudinally controlling the aircraft, or a lateral force control for transversely controlling the aircraft. Additional examples for the actuating system comprise a nozzle and a propeller of the aircraft.

An acceleration of the aircraft in the sense of the disclosure is an acceleration of the aircraft as such, and, for example, consequently not a positioning acceleration of an individual actuator arranged in the aircraft. In particular, an acceleration of the aircraft can preclude an acceleration of an element movably arranged on the aircraft relative to the aircraft, for example a flight control surface of a flight control surface assembly, which involves an acceleration relative to the aircraft.

For example, the acceleration of the aircraft can be an acceleration at a center of gravity of the aircraft, or an acceleration at a fixed part of a flight control surface assembly (fin), wing or fuselage. For example, the acceleration of the aircraft can be the acceleration at a point that is in proximity to a flight control surface, in particular the flight control surface that is controlled by the actuator. In particular, the acceleration of the aircraft can also be an acceleration at a part of the actuator that is immovable relative to the aircraft structure, for example the housing, a baseplate, a control electronics PCB, or another immovable part of the actuator. Such a configuration can simplify system integration, and can enable an independent production by the manufacturer of system components.

In particular, the acceleration of the aircraft can be an acceleration of the aircraft as such in relation to an inertial system or global coordinate system. The acceleration of the aircraft can include the influence of the earth gravitational field and/or a compensation thereof. The acceleration of the aircraft can be a translatory acceleration, a rotational acceleration or an acceleration that incorporates translatory and rotational components.

As a consequence, an actual acceleration of the aircraft provides a controlled variable that depends not merely on the positional deflection of the actuating system (for example, a setting of a flight control surface of a flight control surface assembly or a rotatory or translatory setting of an actuator that moves the flight control surface), but already incorporates additional external influences, in particular influences of wind gusts and/or various flight status variables, such as flight speed, flow angle and rotation rates, which play a role in the aerodynamic force generation. This can make it possible to suppress interferences (gusts) in an inner, more dynamic control loop. A control can be provided that is less sensitive to specific aerodynamic or aeroelastic properties of the aircraft (robustness). In addition, a simpler and more standardized structure can be enabled for the flight control, along with a more agile and precise trajectory guidance.

The device can be provided with a third input interface, which is configured to receive third input data indicating an actuating system controlled variable. Herein, the device is configured to determine an actuating system reference variable taking into account the reference variable and the controlled variable, and to determine the manipulated variable taking into account the actuating system reference variable and the actuating system controlled variable.

The actuating system reference variable can be a target positioning speed of the actuating system, and the actuating system controlled variable can be an actual positioning speed of the actuating system. For example, the actuating system reference variable and the actuating system controlled variable can be a target rotational speed (target rotation rate) and an actual rotational speed of an actuator of the actuating system, for example of an actuator, which moves a flight control surface of a flight control surface assembly. The manipulated variable can be a variable that induces a movement of the actuator, in particular an actuator current in the case of an electromagnetic actuator.

Alternatively, an actuator reference variable, for example a target actuator current, can be determined for an actuator of the actuating system, taking into account the actuating system reference variable and the actuating system controlled variable. Taking into account the actuator reference variable and an actuator controlled variable, for example an actual actuator current, the manipulated variable can be determined, which in particular can be an actuator voltage, for example a terminal voltage of a DC motor, or the transverse voltage component in the case of the field-dependent control of an electronically commutated motor. The device can have a corresponding input interface for receiving the actuator controlled variable. The actuator control or servocontrol can have additional control structures, in particular below a positioning speed control, which are known as such.

In general, the determination of a manipulated variable, possibly of a subordinate manipulated variable in a subordinate control structure, involves determining the manipulated variable as understood in terms of control technology taking into account variables that are predefined, i.e., serve as a reference variable, and variables that are fed back, i.e., serve as controlled variables. In particular, cascade structures can be formed, in which a control deviation as the difference between a reference variable and a controlled variable, which can possibly be determined as a composite controlled variable composed of several controlled variables, is multiplied by a proportionality factor, so as to determine the manipulated variable. Alternatively or additionally, a parallel feedback can be provided, in which one or several controlled variables are fed back with a respective adjustment, for example amplification and/or integration, and offset by addition or subtraction with a reference variable that was modified by means of a prefilter according to the controlled variables that were fed back, in particular to compensate for a static error between the reference variable and the one or several controlled variables.

In order to determine the manipulated variable, the device can be configured to perform several or all of the following operations: Determining a (target) positioning speed (manipulated variable or actuating system reference variable) by multiplying a difference between a target acceleration (reference variable) and an actual acceleration (controlled variable) by a first proportionality factor, determining a (target) actuator current (manipulated variable or actuator reference variable) by multiplying a difference between an actual positioning speed (actuating system controlled variable) by a second proportionality factor; and determining a (target) actuator voltage (manipulated variable) by multiplying a difference between a target actuator current (actuator reference variable) and an actual actuator current (actuator controlled variable) by a third proportionality factor.

The actuator voltage can be the manipulated variable for the control. The actuator voltage can be set according to the manipulated variable, and the reaction to the actuating system thereto, in particular a movement of the actuating system and the assumption of a position of the actuating system can arise from the latter based upon the corporeal and physical system conditions of the system, in particular of the actuating system in conjunction with the system aircraft.

Alternatively, the actuator current can be the manipulated variable of the control. In this case, a target actuator current corresponding to the manipulated variable can be specified for the actuator, wherein no feedback of an actual actuator current takes place. Herein, the actuator can be configured to convert a specified current into a corresponding voltage, so as to achieve the specified current. The actuator can hereon have an internal control, which may for example use the current as a reference and controlled variable and the voltage as a manipulated variable. In particular, it can be provided that the actuator current is the manipulated variable of the control if the actuator sets a specified current with a sufficient dynamic, so as to enable a control of the actuator system that is sufficiently dynamic based upon the respective application, in particular the aircraft type, without a current being controlled by the device.

The device can be configured to operate without considering a positioning acceleration of the actuating system, in particular without considering a positioning acceleration of an actuator, for example without considering a rotary or rotational acceleration of a rotary electromagnetic actuator for moving a flight control surface of a flight control surface assembly. In particular, the manipulated variable can be determined without considering a positioning acceleration. While the positioning acceleration is proportional to the actuating torque, in particular to the drive torque of an actuator, the acceleration of the aircraft at the point can be proportional to the actuator position of the actuating system. For example, a local acceleration at the immovable part of a flight control surface assembly, i.e., at the buoyancy surface, can be proportional to the flight control surface angle and a buoyancy force generated by the latter. Within the controlled system, in particular two integration steps can lie between a positioning acceleration and an acceleration of the aircraft. Feeding back the acceleration of the aircraft, i.e., using the acceleration of the aircraft as the controlled variable, can make it possible to influence the system dynamics in a manner similar to feeding back an actuator position, for example a flight control surface angle.

The device can be configured to determine the manipulated variable without considering an actual actuator position of the actuating system, and without determining a target actuator position of the actuating system. An actuator position of the actuating system can in particular be an actuator position of an actuator, for example a rotational position or a translatory position of an actuator for moving the flight control surface of a flight control surface assembly, or the position of the flight control surface of a flight control surface assembly corresponding to this position.

Alternatively, it may be provided that the device is configured to determine the manipulated variable without determining a target actuator position of the actuating system, while an actual actuator position of the actuating system is considered.

For example, the actual actuator position can be considered in connection with a limitation of the movement space of the actuating system. Herein, the manipulated variable can be modified if a check finds that the manipulated variable would result in a positioning movement outside a specified range of movement of the actuating system, such that the positioning movement ends at the boundary of the range of movement. In particular, this makes it possible to provide a positioning movement that corresponds to the function of a deactivation upon reaching a limit switch. In this case, the manipulated variable can otherwise be determined without considering an actual actuator position of the actuating system, and without determining a target actuator position of the actuating system.

Alternatively or additionally, the actual actuator position can be fed back, for example, in order to observe the state of the transient aerodynamics or elasticities and hysteresis in the drivetrain, so as to enable an additional elevation in control dynamics, wherein the manipulated variable is determined without determining a target actuator position of the actuating system.

The device can comprise an additional input interface, which is configured to receive additional input data indicating an additional controlled variable. Herein, the additional controlled variable can indicate an actual acceleration of the aircraft at an additional point, and the device can be configured to adjust the controlled variable taking into account the additional controlled variable, and subsequently determine the manipulated variable taking into account the reference variable and the controlled variable. For example, adjusting the controlled variable by means of the additional controlled variable can comprise adding the additional controlled variable to the controlled variable. Further controlled variables can be received and correspondingly used for adjusting the controlled variable.

This can make it possible to determine the manipulated variable based on a controlled variable which indicates an acceleration at a point of the aircraft where no acceleration measurement takes place, wherein the acceleration is determined from the accelerations at least at two other points of the aircraft, where an acceleration measurement takes place. As a result, a virtual acceleration measurement can be provided at a measuring point that differs from the point and the additional point of the aircraft. In particular, it becomes possible to use a limited number of acceleration sensors at different points of an aircraft, which at least partially can already be arranged on or in the aircraft for other purposes, to determine accelerations at varying points of the aircraft and/or in varying degrees of freedom. These can serve, for (closed-loop) control and regulation of actuating systems for varying degrees of freedom of the aircraft, for example the elevator, rudder and aileron, as controlled variable in several devices of the kind disclosed, which are allocated to a respective actuating system. Six acceleration measurements at at least at three different points and in at least three varying directions can be provided for an aircraft to be regarded as rigid, so as to determine accelerations at any points of the aircraft.

In general, the acceleration indicated with the controlled variable can be determined from several measurements. The individual can herein determine measuring variables different from an acceleration, so as to infer the acceleration according to the controlled variable. For example, a roll acceleration, in particular around a center of gravity of the aircraft, can be determined from two vertical movements of the wings, wherein the vertical movement is measured by means of corresponding sensors.

Components of the device can be provided as separate devices. Alternatively, individual or all components of the device can be provided as virtual components of one physical component. Components of the device configured as separate physical devices can be mounted together or formed separately from each other.

The reference variable can be determined in an upstream control process, in particular in a flight control device. Herein, the upstream control process can operate with a distinctly lower clock rate than the downstream actuating system control (servocontrol).

With respect to the arrangement, the flight control device can be configured to calculate the reference variable taking into account a controlled variable determined in a directly kinematic manner from a target trajectory of the aircraft.

It can be provided that the reference variable be calculated as a function of an actual flight status of the aircraft and a target flight status of the aircraft, in particular from a deviation or difference between the actual flight status and target flight status. The reference variable can preferably also comprise a pilot control, which is calculated directly from the target flight status and independently of the actual flight status.

A flight status can be given by one or several physical variables or measured values of the latter, which completely or partially characterize the dynamic behavior or permit the determination of such characterizing variables (e.g., with the help of an observer). In particular, a flight status can also comprise variables that are designated as output variables in the context of control technology.

For example, a target flight status can take the form of time progressions or constant values for the physical variables used for describing the flight status. Alternatively or additionally, a target flight status can take the form of a target trajectory of the aircraft. In this case, a determination of a pilot control incorporated in the reference variable can be enabled in an especially easy manner by determining the acceleration at a location of the aircraft from the target trajectory with the help of known kinematic correlations.

For example, a target trajectory of the aircraft can be a line, which describes the desired positional progression of the aircraft center of gravity in the plane corresponding to a flight altitude or in a three-dimensional space. In addition, it can include a time allocation of the positions, i.e., describe a line in a four-dimensional space. Furthermore, the target trajectory can describe a desired time dependence or local dependence of the aircraft attitude, which can be represented for example by one or several angles, rotation matrices or quaternions. The target trajectory can be relative to any coordinate system, preferably to one that is at least approximately inertial. For example, the coordinate system can be an earth-fixed coordinate system, which moves along with the airmass surrounding the aircraft. The angles can be absolute angles, or angles that relate to the direction of the flight path.

The actuating system can be formed with an actuator that moves a flight control surface of a flight control surface assembly of the aircraft. The flight control surface assembly can comprise a fixed part (lift surface), i.e., one that is immovable relative to the aircraft, and a movable flight control surface, which depending on its position relative to the fixed part exerts a desired control effect on the aircraft. Herein, the actuator can be a rotary or translatory electromagnetic actuator, meaning for example an electromotor that rotates the flight control surface relative to the fixed part of the flight control surface assembly. Alternatively, another actuator can be provided, for example a hydraulic or electrohydraulic actuator, in particular with one or several hydraulic cylinders. The flight control surface assembly can be an elevator, a rudder, or an aileron. Given a rotary actuator, for configurations in which the device is designed to determine the difference between an actuating system reference variable and an actuating system controlled variable, the actuating system reference variable can be a target rotational speed (rotation rate), and the actuating system controlled variable can be an actual rotational speed.

In particular, the acceleration sensor can be arranged on a part of the flight control surface assembly that is immovable relative to the aircraft. As a consequence, the arrangement is configured to provide control based on a local acceleration on the flight control surface assembly of the aircraft as an overall system, wherein an acceleration of the flight control surface of the flight control surface assembly relative to the aircraft, in particular relative to the immovable part of the flight control surface assembly, is not acquired, and thus does not enter into the control. For example, an immovable part of a flight control surface assembly can be the fin of an elevator or rudder, or, in the case of ailerons, flaps or spoilers, the wing. An immovable part of the flight control surface assembly can also be part of the flight control surface itself, provided the acceleration measured there essentially reflects the acceleration of the aircraft, i.e., within an approximation sufficient for control, and the relative acceleration triggered by the positioning movement itself has only a subordinate influence. For example, this can be an acceleration measurement on or near the rudder hinge axis, or an installation site of an actuator. In particular, this can be provided for a pendulum rudder, in which there is no separation between the fin and flap, but the entire flight control surface assembly is adjusted instead.

Alternatively, the arrangement can be formed with an actuating system of another kind. For example, the actuating system can be a nozzle of the aircraft, a propeller of the aircraft, a flap, a spoiler, a lateral force control or another actuating system of the aircraft, wherein the actuating system in any event can be controlled by means of the device, and is configured to act in at least one degree of freedom of the aircraft in order to control the aircraft.

The arrangement can be formed with an additional acceleration sensor, which is arranged at an additional point of the aircraft. The device is herein a device with an additional input interface, which is configured to receive additional input data that indicate an additional controlled variable. The additional acceleration sensor is configured to measure the local acceleration at the additional point, and transmit the additional input data indicating the additional controlled variable to the additional input interface of the device, the additional input data indicating the local acceleration at the additional point. The acceleration sensor and the additional acceleration sensor can be used to provide a virtual acceleration measurement at a measuring point that differs from the point and the additional point of the aircraft. The configurations involving the virtual acceleration measurement that were described above with respect to the device can in this case be provided accordingly. The arrangement can comprise several additional acceleration sensors, wherein the device has a corresponding number of input interfaces, and the acceleration sensors can provide one or several virtual acceleration measurements at one or several points, which each differ from the points at which the acceleration sensors are arranged.

The arrangement can also have other sensors, which are not acceleration sensors. Alternatively or additionally, an acceleration sensor can be comprised of several sensors, which each measure a variable different than an acceleration, wherein the acceleration sensor determines the acceleration from the variables of the sensors. For example, an acceleration sensor can be formed with at least two sensors for acquiring a vertical movement on the wings of the aircraft, wherein the acceleration sensor determines a rolling acceleration of the aircraft from the vertical movement of the support surfaces determined by means of the at least two sensors. An acceleration sensor can also consist of one or several force, pressure, expansion, motion, or position sensors, provided that they are arranged and their measured values are processed so as to determine a local acceleration at a location of the aircraft.

The arrangement can have another device according to the disclosure, wherein the aircraft has an additional actuating system, which is configured to control the aircraft in the at least one degree of freedom or in at least one additional degree of freedom, and has an additional acceleration sensor, which is arranged at an additional point of the aircraft. The flight control device can herein be configured to also transmit the input data indicating the reference variable to the additional device via the output interface. The additional acceleration sensor can be configured to measure the local acceleration of the aircraft at the additional point, and transmit second input data indicating an additional controlled variable to the additional device, which indicate the local acceleration at the additional point. Furthermore, the additional actuating system can be configured to receive the manipulated variable from the control output of the additional device, and perform a positioning movement corresponding to this manipulated variable.

A corresponding configuration can provide additional devices and additional actuating systems, wherein the embodiments described above with regard to the actuating system can be correspondingly provided for the additional actuating systems. In this way, a control can be provided for several or all degrees of freedom of movement for the aircraft. Several devices according to the disclosure can be provided as virtual devices in one physical device.

The reference variable provided by means of the flight control device can indicate a target acceleration of the aircraft in several degrees of freedom. For example, degrees of freedom of the aircraft can comprise the positions in three spatial directions and three positional angles. In an elastic aircraft, degrees of freedom can also include variables for characterizing the deformation state, for example modal amplitudes. Alternatively or additionally, degrees of freedom for the aircraft can also be determined by the position of varying points of the aircraft in space.

As an alternative to providing the same (in particular vectorial) reference variable in several disclosed devices, it can be provided that the flight control device provide a respective reference variable for each of the devices, wherein the respective reference variable indicates a target acceleration of the aircraft in a degree of freedom corresponding to the degree of freedom that is primarily, predominantly or exclusively influenced by means of the actuating system allocated to the respective device.

In embodiments with more than one disclosed device, a single acceleration sensor or a single system of several acceleration sensors can be provided instead of a respective acceleration sensor allocated to the devices, which determine an acceleration of the aircraft in several degrees of freedom and/or at several points of the aircraft, if necessary as a virtual acceleration measurement, and provide corresponding, respective controlled variables for the devices of the disclosed kind. The measured values of one or several acceleration sensors can be provided for several of the disclosed devices. The number of provided acceleration sensors, reference variables and disclosed devices do not have to match each other. However, this can be the case in particularly advantageous embodiments, which can make it possible to decouple various degrees of freedom, as well as to specify any system dynamic.

The aircraft can be a highly flexible aircraft. In this case, a complete state feedback can be provided, for example by measuring accelerations at positions distributed over the aircraft with several acceleration sensors, or by separating the rigid body movement from the structural dynamics, wherein a division into rigid body degrees of freedom and amplitudes of the elastic methods takes place, wherein the movement equations of the rigid body movement and structural dynamics are inertially decoupled, but a coupling by way of outside forces (aerodynamics) does exist. In the case of a complete state feedback, an innermost control loop can be provided, in which a locally measured acceleration is fed back. A complete influencing of all eigenforms can herein be enabled, in particular if a number of acceleration points corresponds to a number of considered degrees of freedom. A separate control of rigid body movement and structural dynamics can be provided in outer control loops. For this purpose, it can be provided that rigid body movement and structural dynamics be controlled in a cascade structure. Target values for accelerations of the rigid body degrees of freedom and modal degrees of freedom can be converted into target values for the local accelerations, for example by means of eigenvectors and kinematic translations. The outer control loops can relate to generalized coordinates, while inner control loops relate to the local degrees of freedom. The system behavior can be independent of the form of description, wherein a transformation between various degrees of freedom systems and state representations can be enabled.

For an embodiment with a highly flexible or elastic aircraft, it is alternatively possible to provide a local acceleration measurement on the actuating system, in the case of a flight control surface assembly in particular directly at the flight control surface on an immovable part of the flight control surface assembly, wherein the local acceleration is used exclusively for controlling the actuating system on which the measurement is performed. The number of actuating and measuring positions can be suitably selected, and can correspond to the number of considered degrees of freedom, so as to make it possible to freely specify a system dynamic in this case as well. In an elastic aircraft, relative movements caused by the elastic deformation can arise between a part of the flight control surface assembly that is immovable relative to the aircraft and other parts of the aircraft, for example a part of the fuselage or the center of gravity of the aircraft.

In general, the aircraft can be any kind of aircraft, for example a slightly flexible or elastic, moderately flexible or elastic, or highly flexible or elastic aircraft. In particular, a highly flexible (elastic) aircraft can be an aircraft that can no longer be described with sufficient accuracy by means of a linear approach. In a flexible aircraft, the acceleration of the aircraft can in particular be an acceleration of the elastic aircraft structure at a point where aeroelastic vibration modes (eigenforms) have an extremum or nodal point.

The method for control and closed-loop control of an actuating system of an aircraft can comprise receiving third input data that indicate an actuating system controlled variable at a third input interface of the device, wherein determining the manipulated variable taking into account the reference variable and the controlled variable comprises determining an actuating system reference variable taking into account the reference variable and the controlled variable, and determining the manipulated variable taking into account the actuating system reference variable and the actuating system controlled variable.

The configurations described above with respect to the device for controlling and regulating an actuating system of an aircraft can be correspondingly provided in connection with the device and/or the method, and vice versa. In particular, the device can be configured to function with the components described in connection with the arrangement, and the arrangement can have components that are configured to provide the described functions in conjunction with the device.

Provided according to the disclosure is a device for control and closed-loop control of an actuating system of a vehicle, which is comprised of a first input interface configured to receive first input data indicating a reference variable, a second input interface configured to receive second input data indicating a controlled variable, and a control output configured to output a control signal indicating a manipulated variable for an actuating system of a vehicle to be controlled by means of the actuating system. The reference variable indicates a target acceleration at a point of the vehicle to be controlled by means of the actuating system, and the controlled variable indicates an actual acceleration of the vehicle at the point. The device is configured to determine the manipulated variable from the difference between the reference variable and the controlled variable, and to output the control signal corresponding to the manipulated variable via the control output. In connection with the device for control and closed-loop control of an actuating system of a vehicle, the statements made in relation to the device for control and closed-loop control of an actuating system of an aircraft can be correspondingly provided. In particular, the disclosure provides a corresponding arrangement for control and closed-loop control of an actuating system of a vehicle, with a vehicle having an actuating system and an acceleration sensor, a vehicle control device with an output interface and a device for controlling and regulating an actuating system of a vehicle. Further, a corresponding method for control and closed-loop control of an actuating system of a vehicle is provided in line with the disclosure. In particular, the vehicle can be an aircraft, for example an airplane, helicopter, or blimp. Alternatively, for example, the vehicle can be a watercraft or spacecraft.

### DESCRIPTION OF EXEMPLARY EMBODIMENTS

Additional exemplary embodiments will be described in more detail below with reference to figures of a drawing. Shown here on:

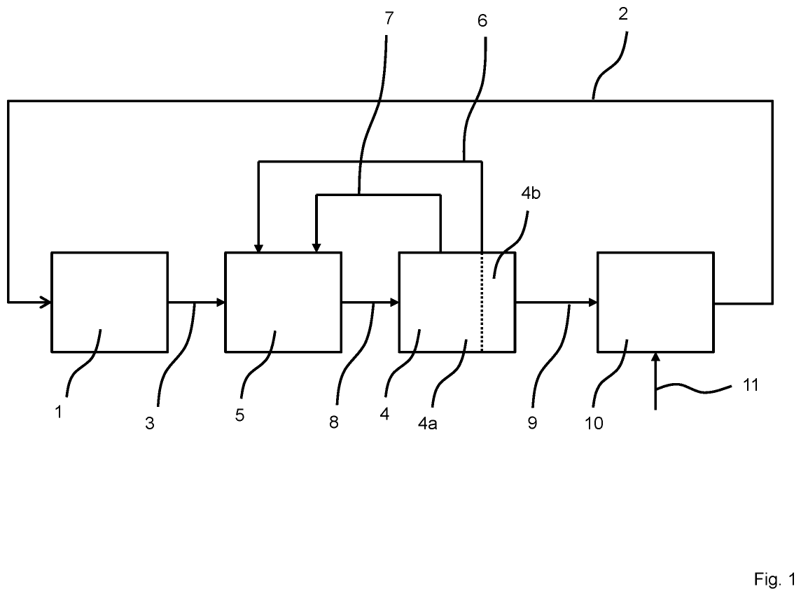

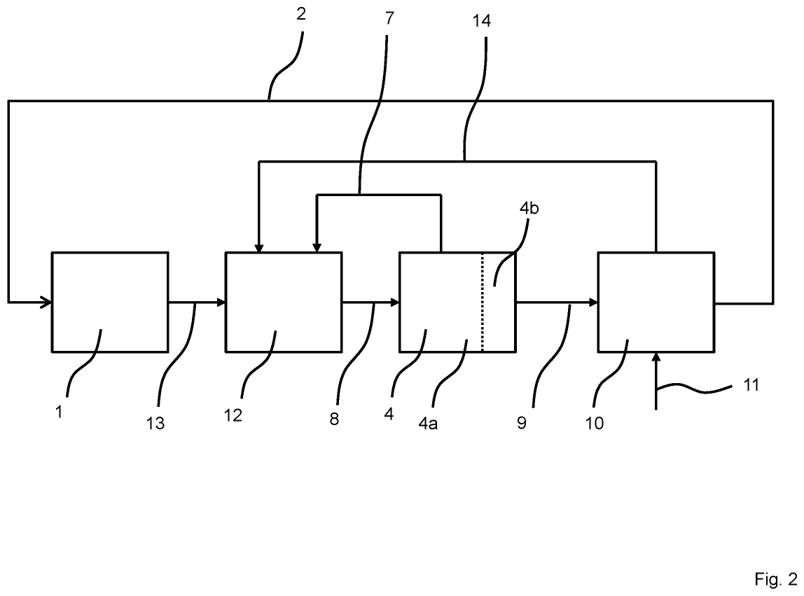

FIG. 1 is a known arrangement for control and closed-loop control of an actuating system of an aircraft;

FIG. 2 is an arrangement for control and closed-loop control of an actuating system of an aircraft according to the disclosure;

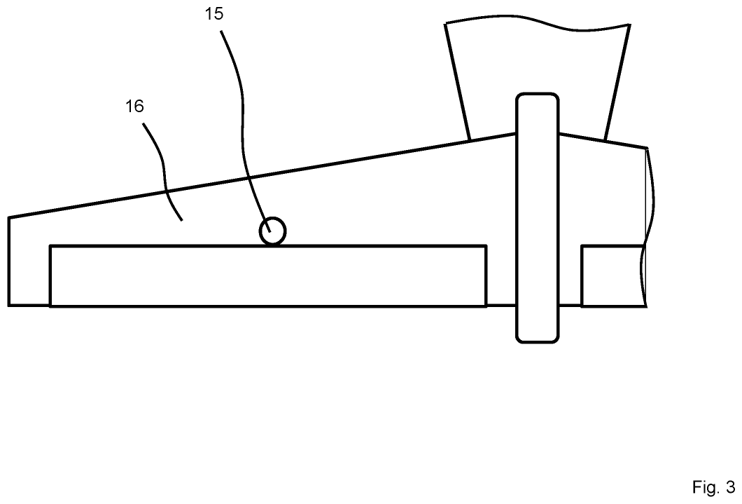

FIG. 3 is an arrangement of an acceleration sensor on an elevator of an aircraft;

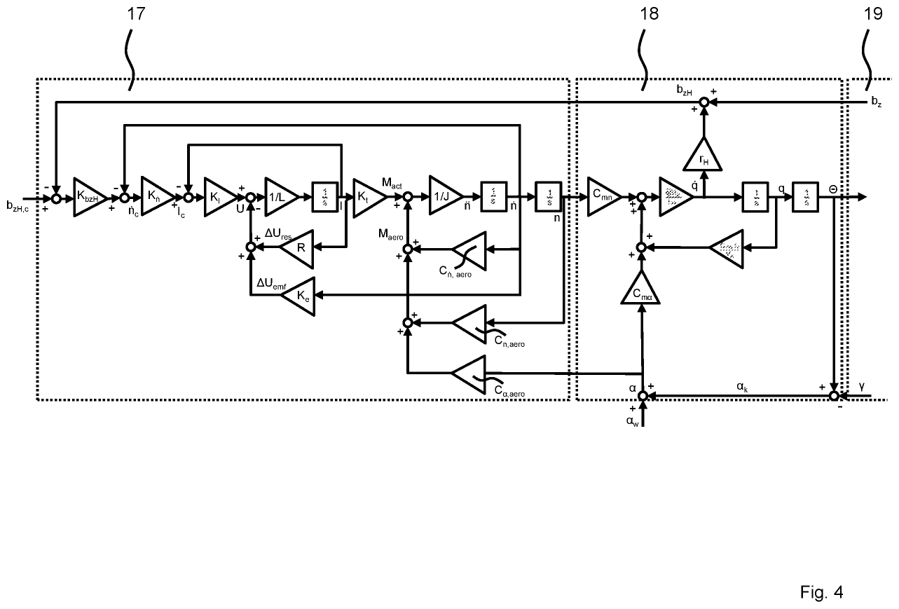

FIG. 4 is another arrangement for control and closed-loop control of an actuating system of an aircraft;

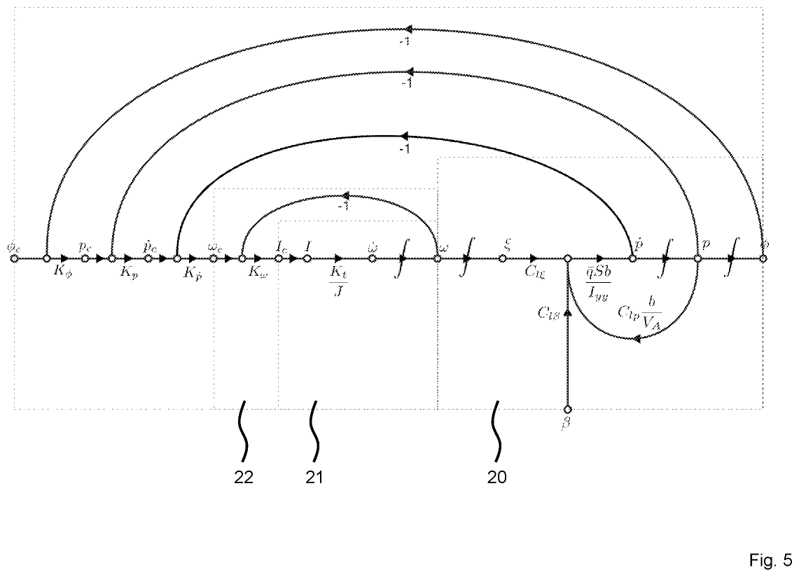

FIG. 5 is a schematic illustration of a concept for an acceleration-based roll position control of an aircraft;

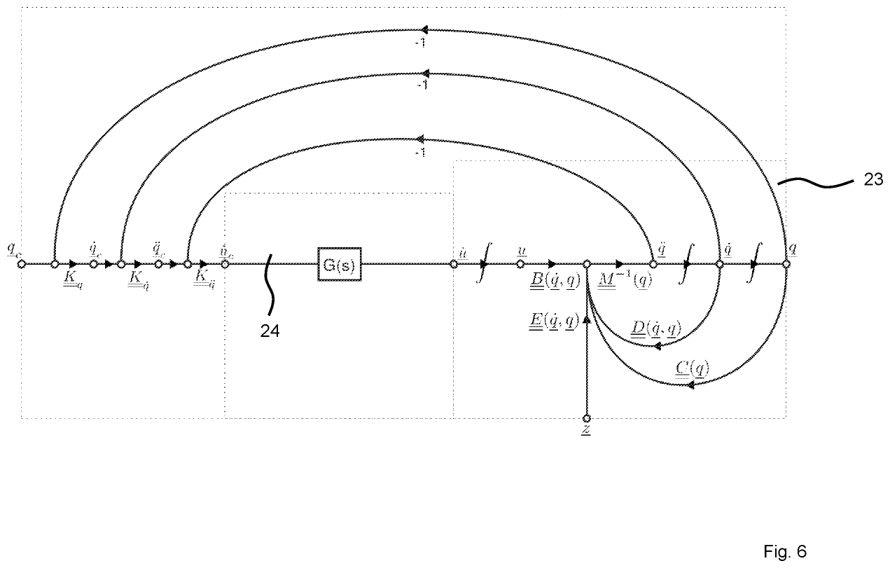

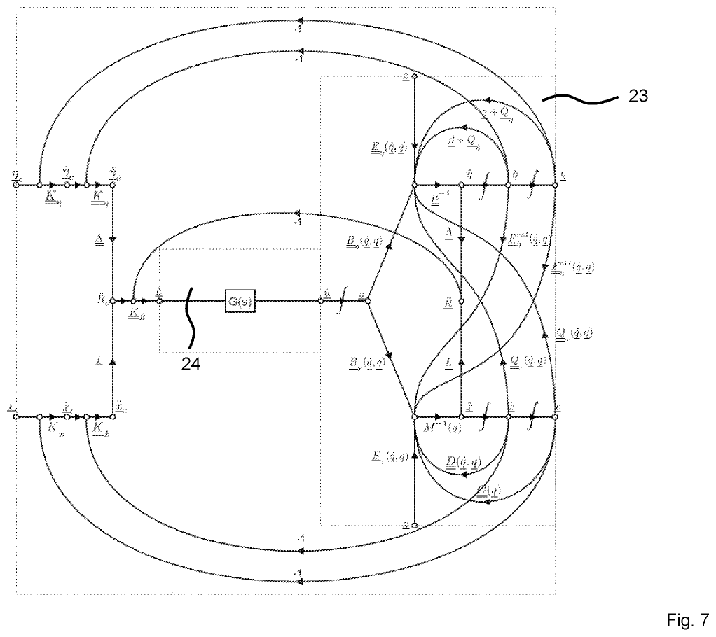

FIG. 6 is a schematic illustration of a concept for an acceleration-based control of mechanical systems;

FIG. 7 is a schematic illustration of a concept for an acceleration-based control of elastic aircraft;

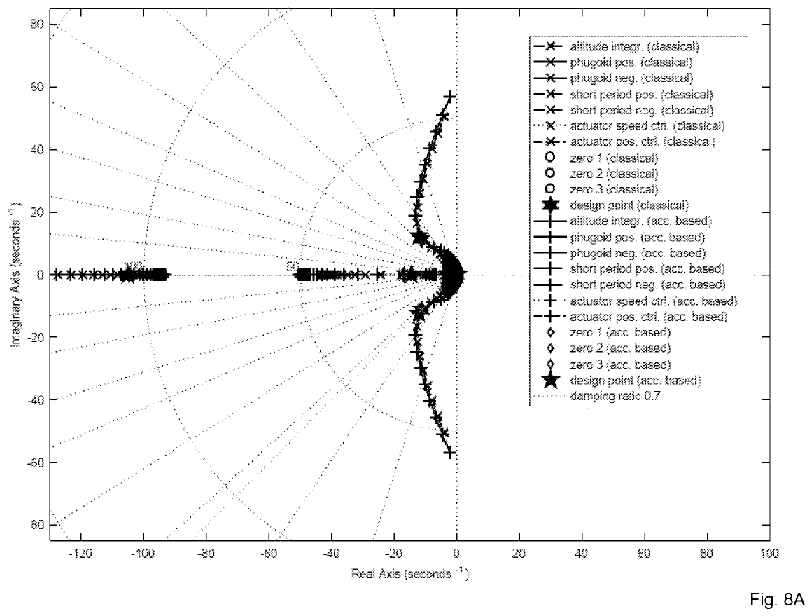

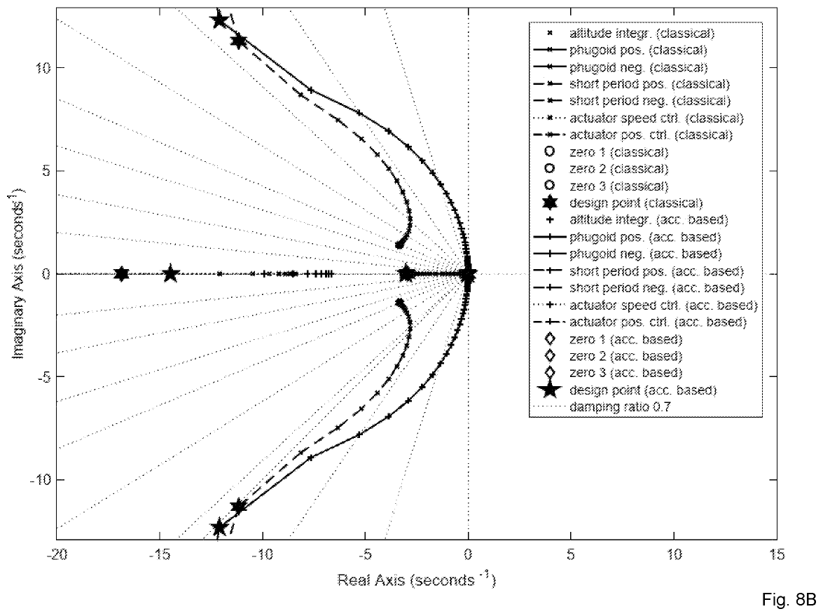

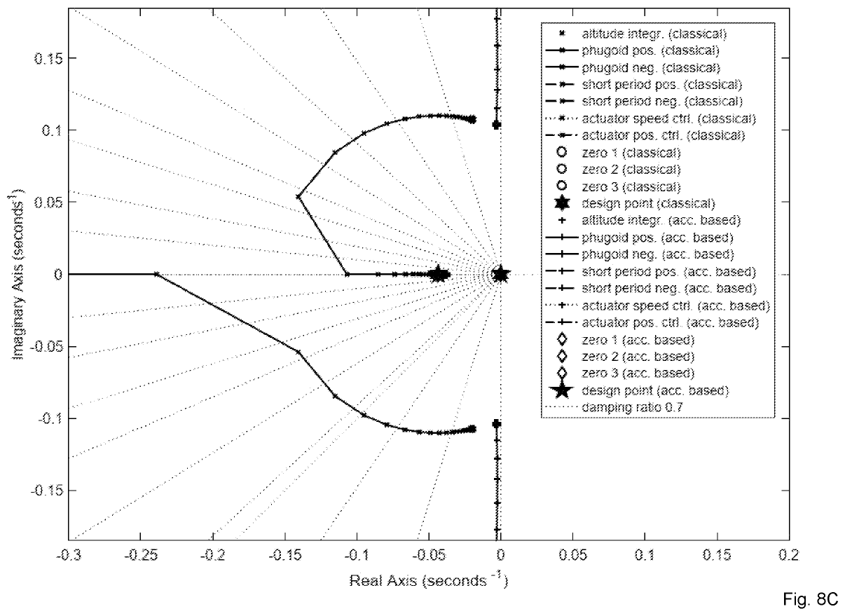

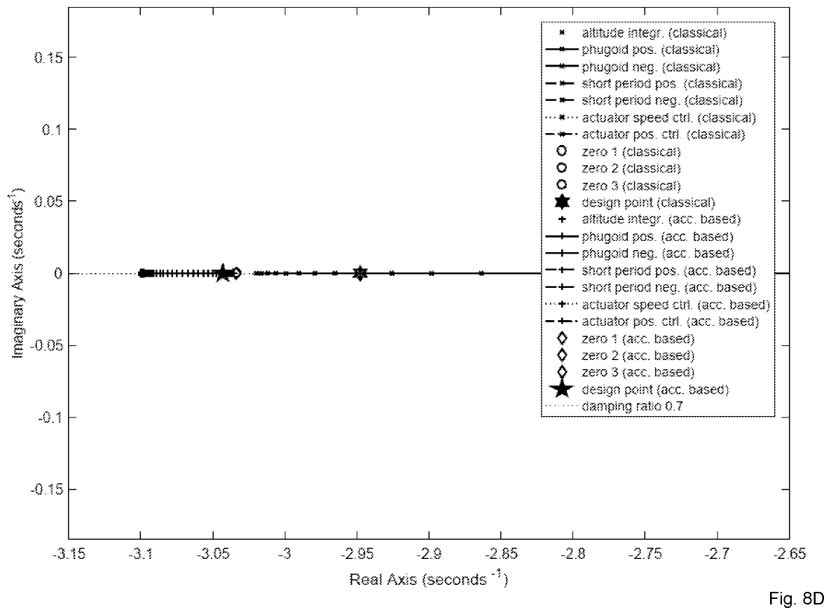

FIG. 8A-E is the overall system dynamics for a known as well as for a disclosed closed-loop control of an actuating system of an aircraft;

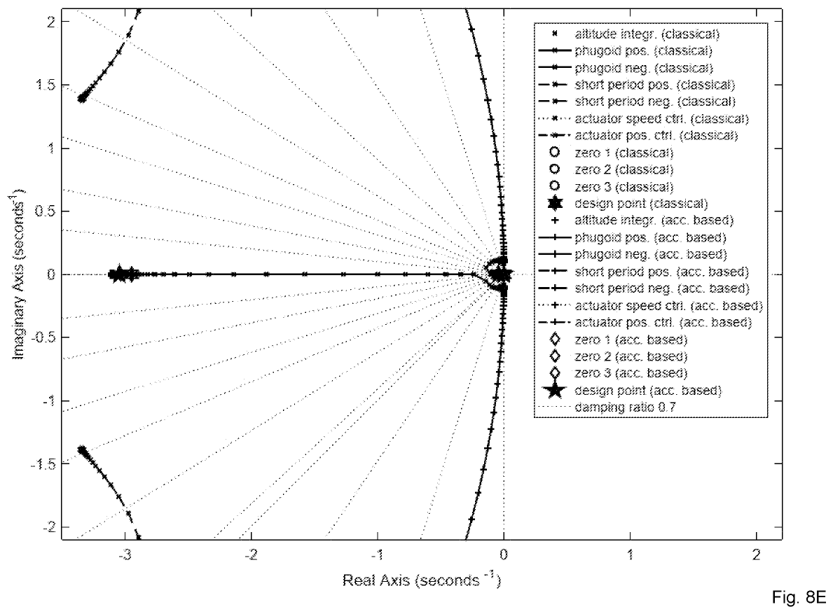

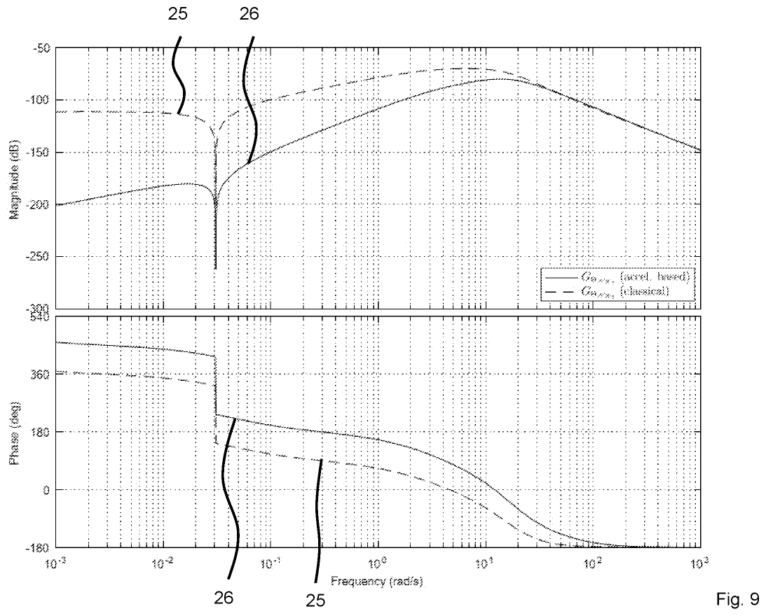

FIG. 9 is a Bode diagram for a previously known and for an embodiment according to the disclosure of a closed-loop control of an actuating system of an aircraft;

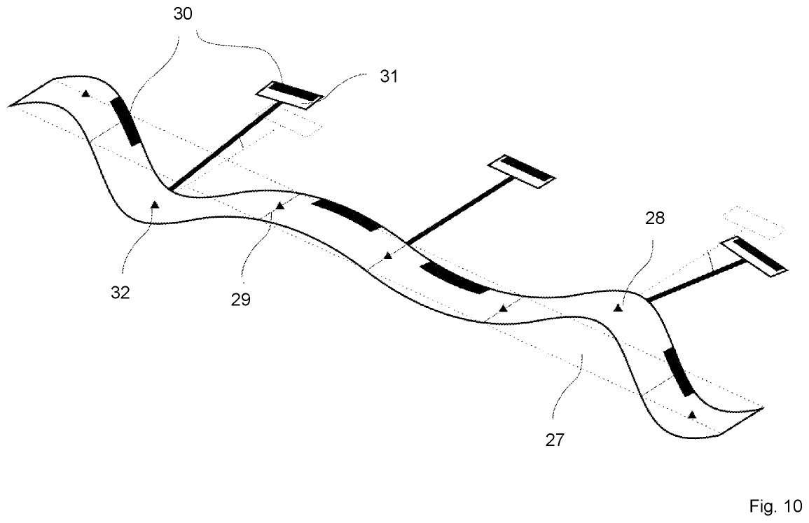

FIG. 10 is a schematic illustration of an arrangement on a flexible aircraft; and

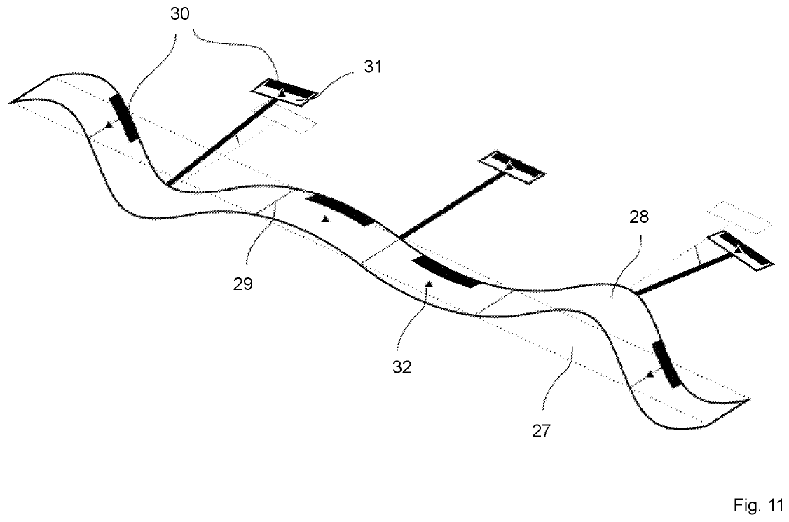

FIG. 11 is a schematic illustration of an alternative arrangement on a flexible aircraft.

FIG. 1 shows an arrangement for controlling and regulating, i.e. for control and closed-loop control of, an actuating system of an aircraft according to a known approach. A flight control device 1 of the aircraft, which involves an automatic control system that can also be referred to as a flight control system, herein receives measured variables 2 for describing the movement state of the aircraft. Based on the movement state of the aircraft, the flight control device 1 determines a reference variable 3 for controlling the actuating system 4. Herein, the actuating system 4 is formed with a control element 4a and a force generator 4b, wherein the actuating system can comprise additional components. In particular, the force generator 4b can be a flight control surface of a flight control surface assembly, and possibly fixed components of the control assembly that participate in generating the force. For example, the force generator 4b can alternatively be a nozzle or propeller. The control element 4a is used to influence the force generator 4b in such a way that a desired force acts upon the controlled system, i.e., the aircraft. In configurations where the actuating system 4 is a flight control surface assembly, the control element 4a can be a servomotor, which swivels a flight control surface of a flight control surface assembly as a force generator 4b or part of the force generator relative to an immovable part of the flight control surface assembly. In alternative configurations, for example, the control element 4a can be a valve of a nozzle serving as the force generator 4a, or a drive motor of a propeller.

The reference variable 3 indicates a target actuator position of the control element 4a of the actuating system 4, for example a rotational position of a servomotor (corresponding to a flight control surface position), an opening state of a valve of a nozzle, or a drive position of a drive motor of a propeller, which results in a propeller speed, or a servomotor for blade angle adjustment.

A control device 5 of the arrangement receives the reference variable 3 via a corresponding input interface. In addition, the control device receives a controlled variable 6 by way of another input interface, which indicates the actual actuator position of the actuating system. The control device determines the control deviation as the difference between the target value of the actuator position according to the reference variable 3 and the actual value of the actuator position according to the controlled variable 6. An actuating system reference variable is determined from the control deviation through multiplication by a proportionality factor in the control device 5, and is compared to an actuating system controlled variable 7, so as to determine a manipulated variable 8 of the actuating system. For example, the manipulated variable 8 can be an actuator voltage or an actuator current.

The control element 4a effects a position of the force generator 4b based on the manipulated variable 8. As a result, a force and/or torque effect 9 acts upon the mechanical system 10 of the aircraft. While the aircraft as a mechanical system 10 is shown separately from the remaining components in FIGS. 1 and 2, the actuating system 4 and, in advantageous embodiments, the flight control device 1 and control device 5 also form part of the aircraft.

Apart from the desired force and/or torque effect 9, the mechanical system 10 of the aircraft is also exposed to disturbing forces and/or torques 11, which are caused by outside influences, for example wind exposure, in particular in the form of wind gusts. As can be discerned from the illustration in FIG. 1, the disturbing forces and/or torques 11 acting on the aircraft can only be compensated for by the flight control device 1 if measured variables 2 that include the influence of the disturbing forces and/or torques 11 are considered. As a consequence, this type of consideration takes place exclusively within the framework of flight control, which is usually slow by comparison to the actuating system control (servocontrol).

FIG. 2 now shows an arrangement for control and closed-loop control of an actuating system of an aircraft according to the disclosure. According to the disclosure, in comparison to the arrangement in FIG. 1, a device 12 for control and closed-loop control of the actuating system 4 is provided that is configured to receive a reference variable 13 at a first input interface, which reference variable 3 indicates a target acceleration at a point of the aircraft. To this end, the flight control device 1 is configured to determine the reference variable 13 indicating the target acceleration from the measured variables 2, and to transmit it to the device 12. At a second input interface, the device 12 receives a controlled variable 14 that indicates the actual acceleration at the point of the aircraft.

In particular, the acceleration of the aircraft can be a local acceleration at the actuating system 4. FIG. 3 exemplarily shows the arrangement of an acceleration sensor 15 on the immovable part of an elevator 16 of an aircraft. Herein, the elevator 16 is an actuating system 4 of the aircraft in which a movement of the flight control surface of a flight control surface assembly functioning as the force generator 4a by means of a servomotor as the control element 4a exerts a force on the aircraft, which leads to a pitching, and thereby causes the aircraft to rise or sink.

Alternatively, the acceleration can be an acceleration at another point of the aircraft, for example in a center of gravity of the aircraft. The acceleration can be measured directly with an acceleration sensor, or determined from one or several measured values, which can include accelerations at one or several other points or other variables than accelerations, for example vertical movements (changes in position) of the wings.

The control device 12 determines the control deviation as the difference between the target value for the acceleration according to the reference variable 13 and the actual value for the acceleration according to the controlled variable 14. An actuating system reference variable is determined from the control deviation in the control device 12 through multiplication by a proportionality factor, and compared with an actuating system controlled variable 7, so as to determine a manipulated variable 8 of the actuating system. Based on the manipulated variable 8, the control element 4a produces a positioning of the force generator 4b that leads to a force effect 9 on the mechanical system 10 of the aircraft.

In an alternative configuration, such a cascade structure can be replaced by a parallel feedback, in which the controlled variables 7 and 14 are fed back, and are herein each modified, in particular multiplied by an amplification factor and/or integrated. The reference variable 13 is modified according to the controlled variables 7 and 14 by means of a prefilter, after which the manipulated variable 8 is determined by adding the controlled variables 7, 14 and reference variable 13.

As may be seen in FIG. 2, the controlled variable 14 is a variable of the mechanical system 10 of the aircraft. The disturbing forces and/or torques 11 influence the acceleration of the aircraft, so that the acceleration of the aircraft indicated with the controlled variable 14 already contains these influences, at least in part. In comparison to the known concept illustrated in FIG. 1, the control concept illustrated in FIG. 2 thus already achieves a consideration of disturbing forces and/or torques 11 acting on the aircraft in the control of the actuating system 4 of the aircraft.

In particular, the manipulated variable 8 can be an actuator voltage or an actuator current. For example, the actuating system reference variable can be a target value for a positioning speed of the control element 4a, i.e., in particular of an actuator. In this case, the actuating system controlled variable 7 can be an actual positioning speed of the control element 4a. In an exemplary configuration, a target value for an actuator current is determined from the difference between the actuating system reference variable and the actuating system controlled variable. The target variable for the actuator current can be the manipulated variable 8. Alternatively, an additional inner control loop can be provided, in which the manipulated variable 8 is determined using the target value of the actuator current.

FIG. 4 shows such a configuration of an arrangement for control and closed-loop control of an actuating system of an aircraft, in which another inner control loop is provided. Exemplarily shown here is a pitching position control with a rotary, electromagnetic actuator of an elevator. As opposed to a known control with feedback of a flight control surface deflection n, a local acceleration b_{zH} at the elevator is fed back, and a control deviation to a specified acceleration b_{zH,c} is determined within the actuating system control 17. Applying the factor K_{bZH}, a proportional positioning speed command \dot{n}_{c} is determined from the above, which is set by the inner speed control loop. The commanded current flow I_{c} (actuator reference variable) results proportionally (factor Kₙ) from the speed error \dot{n}_{c}−\dot{n}, the difference between the positioning speed command \dot{n}_{c} (actuating system reference variable) and the actual positioning speed n, which is the actuating system controlled variable. Finally, the terminal voltage U of the motor forms the manipulated variable. It is set proportionally (factor K_{I}) to the control error I_{c}−I of the current control cascade. Herein, the actual current I constitutes the actuator controlled variable.

Within the framework of the physical processes within the actuator corresponding to a modeling as a DC shunt machine, the terminal voltage causes a change in the current flow in the motor windings that is anti-proportional to its inductivity L. However, consideration must be given to the voltage drop ΔUᵣₑₛ=R·I owing to the winding resistance R, as well as to the counter-voltage ΔU_{emf}=Kₑ·\dot{n} induced by the rotational movement proportional to the motor constant Kₑ, which diminish the terminal voltage. The current flow I arises through integrating the current change, and produces a drive torque M_{act} proportional to the motor constant Kt.

With respect to the physical effect on the actuating system, in addition to the drive torque M_{act}, the aerodynamic rudder hinge moment Mₐₑᵣₒ acts on the flight control surface, which along comprises both components proportional to the deflection n with the factor C_{n,aero} and damping components (factor C_{\dot{n},aero}). In addition, the aerodynamic rudder hinge torque Mₐₑᵣₒ is influenced by the direction of inflow (factor C_{α,aero}). The resulting overall torque leads to a positioning acceleration \ddot{n} that scales with the inverse 1/J of the rotational inertia.

Shown in the right part of FIG. 4 is a simplified view of the dynamics underlying the aircraft pitching movement 18. The pitching acceleration q is proportional to the pitching torque with the inverse pitching inertia 1/I_{yy}, which arises from the pitching torque coefficient through denormalization with dynamic pressure q̅, wing area S and wing depth I_{μ}. The latter essentially comprises influences of the elevator (Cₘₙ·n), pitching rate (C_{mq}·I_{μ}·1/V_{A}·\dot{q}) and angle of attack (C_{mα}·α). Apart from the share of elongation Θ, the angle of attack α is determined by the influence γ of the path movement 19. In addition, it contains the main part of the disturbing influence (gusts) in the form of the wind adjustment angle α_{W}. The local acceleration b_{zH} at the elevator arises from the pitching acceleration \dot{q} with the lever r_{H}, as well as from the vertical acceleration b_{Z} of the aircraft center of gravity.

According to the disclosure, the actuator position is not drawn upon as the controlled variable, for example as evident from FIG. 4. No force or torque measurement serves as the controlled variable either. In addition, the controlled variable is not measured in the drivetrain of the actuator or on the flight control surface, but rather on the assembly allocated to the flight control surface (the lift surface immovable relative to the aircraft) in the embodiment of FIG. 4. No measurement of the (rotational) acceleration \ddot{n} of the actuator takes place that would be proportional to the positioning torque (drive torque of the actuator, M_{act}). Rather, the local acceleration on the lift surface instead behaves proportionally to the flight control surface angle and the lifting force it generates, i.e., to a variable that is separated from the acceleration \ddot{n} of the actuator by two integration steps, as evident in FIG. 4. The local acceleration is an output variable which to a substantial extent depends on the flight control surface angle n as a system state, and the feedback of which thus enables influencing the system dynamics in a similar manner. According to the embodiment shown in FIG. 4, the speed control loop of a classic servocontrol (middle cascade in FIG. 4) is to be retained, so that there still is a continued feedback of a number of linearly independent output variables corresponding to the system order. This can make it possible to configure the system dynamics as desired. As “rigid” a layout of the rudder angle dynamics as possible may herein be desired. In particular, reducing the actuator load or positioning effort might not be the goal; rather, it can be provided that the flight control surface be moved as quickly as possible into the position that compensates for the influence of gusts on the corresponding flight control surface assembly. This position is generally not identical to the resting position, into which the free rudder would be deflected with the setting torque held constant.

Local acceleration control can yield advantages over controlling the rudder hinge torque. The local acceleration measurement (as opposed to the flight control surface angle or rudder hinge torque) directly captures the added lift caused by the gust via the additional angle of attack aw. In elastic aircraft, the local accelerations directly reflect the structural dynamic vibration state. Feeding the acceleration back to the positioning speed of a flight control surface acting at the same location corresponds to a virtual dampening (similar to the so-called ILAF principle). Therefore, it can be suitable in particular for actively stabilizing highly elastic configurations. Furthermore, the local acceleration includes influences of various flight state variables (Θ, γ, q, see FIG. 4), which can also be compensated for by the control. These influences can become less important as compared to the highly dynamic feedback path via K_{bz,H}, so that a significantly larger robustness can arise in relation to variable aerodynamic properties. In a direct, purely kinematic relation, the local acceleration can be determined from a planned path and attitude trajectory. This makes it possible to derive simple pilot control laws, which are independent of the properties of a specific aircraft. In this way, the high dynamics of the local acceleration control (which correspond to the classic position control loop of the servocontrol) can be taken advantage of not just for interference suppression, but also for guidance behavior. This can enable a significantly more agile path guidance.

Actuator control (servocontrol) and flight state control (flight control) represent traditionally separate research disciplines, which are covered in different expert circles. The feedback of a local acceleration measured on the aircraft structure in an inner control loop, which is traditionally part of the servo control, builds a bridge between the two areas. This requires a holistic examination of the entire controlled system, which interprets the aircraft and its control elements as a unit. Using the local acceleration as a default variable makes it possible to include parts of the flight dynamic in the controlled system of the servocontrol. It can become possible to simplify the controlled system of the flight control, and reduce dependencies on specific flight properties, so that classic flight control structures are no longer applicable.

According to illustration 4, the boundary for the actuating system control 17 is drawn at local acceleration b_{zH} and flight control surface deflection n. Other illustrations are possible, in which the definitions of subsystems, in particular of the boundaries, are set differently (e.g., see FIG. 5), without this resulting in a change in the disclosed control principle.

The symbols used in FIGS. 5, 6 and 7 denote the following variables:

Scalars:

C_{Iβ}: Sliding roll torque

C_{Iξ}: Aileron effectiveness

C_{Ip}: Roll damping

I: Actuator current

I_{yy}: Rolling inertia torque

J: Torque of Inertia of the actuator

Kₜ: Torque constant of the actuator

K . . . : Controller amplification of the . . . -control loop

S: Wing surface

V_{A}: Flight speed

q̅: Dynamic pressure

b: Half span

p: Roll rate

β: Shift angle

β_{W}: Wind shift angle

Ω: Angular velocity of the actuator

ξ: Aileron deflection

Vectors:

η: Modal amplitudes (structural dynamic degrees of freedom)

R: Position vector for the local acceleration measuring point

g: Generalized coordinates

u: Manipulated variables

x: Rigid body degrees of freedom

z: Disturbance variables

Matrices and Tensors:

BηPositioning influence on generalized forces of the structural dynamic degrees of freedom

Bχ: Positioning influence on generalized forces of the rigid body degrees of freedom

B: Positioning influence on generalized forces

C: Generalized rigidity matrix

D: Generalized damping matrix

E_{η}: Disturbance influence on generalized forces of the structural dynamic degrees of freedom

Eₓ: Disturbance influence on generalized forces of the rigid body degrees of freedom

E: Disturbance influence on generalized forces

E_{η}^{ext}, E_{η}^{ext}: Influence of the structural deformation-induced aerodynamic forces on rigid body movement

K . . . : Amplification matrix of the . . . -control loop

L: Kinematic translation ratios between generalized rigid body degrees of freedom and position of the local acceleration measuring points M: Generalized inertia matrix

Q_{η}, Q_{η}: Influence of the structure deformation-induced aerodynamic forces on structural dynamics

Qₓ, Qₓ: Influence of the rigid body movement-dependent aerodynamic forces on structural dynamics

Δ: Eigenforms (eigenvectors) of the structural dynamics

β: Generalized structural damping factors

γ: Generalized rigidity matrix

μ: Modal mass matrix

Indices:

c: Command size, default value, target value

In classic flight control, the command corresponds to the position (angle) of the aerodynamic flight control surface. A highly dynamic (rigid) positional control of the actuator ensures that the actual flight control surface position precisely follows the positioning command. The control structure corresponds to a cascade control with an inner control loop, the actuator control (ACL), and an outer control loop, the flight control (FCL). A feedback of position angles, rotation rates and speeds takes place. As a rule, acceleration measurements are only used for observation or as a replacement for poorly measurable states.

Also known is a rudder hinge torque-based flight control. The command for the FCL corresponds to a torque specification, meaning a direct current specification, for the actuator. In a state of equilibrium, the torque specification corresponds to the aerodynamic rudder hinge torque. The concept is similar to the force-oriented control behavior of the pilot during manual control. This type of control is supposed to offer advantages with respect to flight silence and load reduction, since the control surface deviates owing to an altered hinge torque of the gust. This is intended to reduce an actuator load and force fight in the case of redundant actuators.

A local linearization and inversion of the system dynamics takes place in the likewise previously known incremental nonlinear inversion (INDI). Incremental growths in the positioning command are calculated. The method is based on measured and commanded (rotational) accelerations, and reduces the influence of the (aerodynamic) model accuracy and center of gravity for elevated robustness. The positioning law is herein based upon the comparison between planned and actual changes (and thus, derivations) of the state variables, which are calculated or observed based on rotatory and translatory acceleration measurements. As opposed to the concepts disclosed herein, a direct use of this change in positional variable in an inner cascade of the servocontrol or an expansion of the INDI approach to the actuator dynamics is not known for this approach. In a proposed approach, the actuator current serves as a given variable, and a positioning law modified for this purpose is derived. As opposed to the approach according to the present disclosure, the quasi-stationary dependence of the actuator current on the rudder hinge torque is taken as the basis, so that the dynamics of the actuating system themselves remain unregulated.

Feeding back acceleration measurements or modal degrees of freedom is known for an active flutter control and load reduction. Herein, the command corresponds to the flight control surface position. Alternatively, additional forces are applied by vibration actuators. This often does not take place in terms of closed-loop control, but specifically to compensate for individual resonance frequencies.

In the known systems, the dynamics (bandwidth) of the flight controller to a large extent determine the precision of path and position maintenance (interference suppression), flight silence (interference suppression), and agility of path guidance (guidance behavior). The maximum bandwidth is limited by the dynamics of the independently configured actuator control (inner control loop), and possibly also by the dynamics of the mechanical transmission path between the actuator and flight control surface, the structural dynamics of an elastic aircraft, and the transient aerodynamics. A precise aerodynamic model is required for an optimal FCL configuration. This is costly and can be associated with a lack of robustness. The inner control loops, at least the position control, must be individually designed for each aircraft type. A precise aeroelastic model is required to preclude excitations of the structural dynamics. Having the flap deflection ilk act directly on the vertical load multiple (i.e., the load acceleration) n_{Z} complicates the design of a gust load control. Abatement potential is limited without the provision of a pilot control, which is accompanied by a complex angle of attack measurement.

FIG. 5 shows a schematic illustration of a concept for an acceleration-based rolling position control of an aircraft. In comparison to the known system, the position control of the actuators is replaced by the feedback of an acceleration measurement, which determines the aerodynamic force effect of the flight control surface (for example, local acceleration at the flight control surface or rotational acceleration of the aircraft). The classic division between actuator control and flight control is altered herein. The interface between FCL and actuator control slides inwardly by one cascade. The state feedback of the actuator deflection is replaced by an output feedback of the acceleration proportional thereto, which additionally contains the interference influence (gusts). The command of the FCL then corresponds to the positioning rate (angular velocity) of the flight control surface. A measurement of the flight control surface position is only required to consider the positional limit.

In the case of an aircraft, the controlled system of the FCL, the rolling torque coefficient C_{I} is proportional to the aileron deflection ξ, which in known systems constitutes the manipulated variable, with the factor C_{Iξ}. The rolling torque coefficient C_{I β} is proportional, with the factor C_{I}, to the shift angle β, which is construed as a disturbance variable for pure rolling control, and in particular incorporates the wind influence β_{W}. The rolling torque coefficient C_{I} is proportional, with the factor C_{Ip}, to the dimensionless rolling rate p*=p·b/VA. The rolling torque follows from the coefficient C_{I} through multiplication by the reference variables (q̅, S, b), with the rolling acceleration also being proportional to the inverse rolling inertia (1/I_{yy}). The rolling rate p and rolling angle Φ arise through integration from the rolling acceleration. Known flight control comprises the complete feedback of the states “rolling rate (p)” and “suspension angle (Φ)”. Herein, the system is set up in the form of a cascade control, in which the outer control loop comprises the rolling position with the reference variable “rolling command (Φ_{c})” and manipulated variable “rolling rate command (p_{c})”, which with amplification K_{Φ} is proportional to the control error Φ_{c}-Φ. The inner control loop then relates to the rolling rate with the reference variable “rolling rate command (p_{c})” and manipulated variable “aileron command (ξc)”, which with the amplification Kₚ is proportional to the control error p_{c}-p.

For the actuator, the control system ACL, the actual current flow I corresponds to the current command I_{c} when disregarding the electrical time constant. The torque with torque constant Kₜ is proportional to the current flow. Additional torque coefficients (friction, aerodynamic rudder hinge torque, etc.) are disregarded. The rotational acceleration (ω⁻) of the downforce follows from the conservation of angular momentum as the torque/inertia torque (J). The positioning speed (ω) and downdraft angle (which corresponds to the aileron deflection ξ) follow through integration of the rotational acceleration. Known actuator control then involves the complete feedback of the states “positioning speed (ω)” and “actuator position (ξ)”. The system is set up in the form of a cascade control, in which the outer control loop comprises the actuator position with the reference variable “aileron command (ξ_{c})” and manipulated variable “setting rate command (ω_{c})”, which with the amplification K_{ξ} is proportional to the control error ξ_{c}-ξ. The inner control loop then relates to the positioning speed with the reference variable “setting rate command (ω_{c})” and manipulated variable “current command (Ic)”, which with the amplification K_{ω} is proportional to the control error ω_{c}-ω.

By comparison to the above, FIG. 5 shows an acceleration-controlled concept with the controlled system aircraft 20, the actuator 21 and the controlled system actuator 22. The measured rolling acceleration (\dot{p}) is fed back instead of the aileron deflection (ξ) proportional thereto. The command ω_{c} of the FCL corresponds to the positioning rate ξ. Apart from the flight control surface position ξ, the disclosed feedback also directly acquires the interference influence through β or β_{W}. As a consequence, the disturbance is already compensated for one control loop further in than for known flight control. Given a highly dynamic configuration of this acceleration control loop (\dot{p}-feedback), significantly better interference suppression can be achieved. The default value for the position control loops (traditional “inner loops” of the FCL) corresponds directly to the rate acceleration (second derivation of the controlled variable). Given a highly dynamic configuration of acceleration control, the aircraft directly follows the specified rate acceleration (\dot{p}_{c}≈\dot{p}). This yields a simple, linear behavior independent of aircraft-specific parameters. The configuration of position control can be standardized, and can take place independently of the aircraft type and flight status. Given a highly dynamic configuration, the acceleration feedback via K_{\dot{p}}·C_{Iξ} becomes dominant relative to the remaining aerodynamic influences (via C_{Iβ} and C_{Ip}), whereby the influence of aerodynamic parameters (other than C_{Iξ}) on the control circuit is reduced. This makes it possible to forego a precise aerodynamic model for the FCL configuration. Only the rudder effectiveness C_{Izi} and dynamic pressure remain relevant. Preventing the positioning command from acting directly on the acceleration measurement simplifies the configuration and elevates the potential of control-based gust load reduction.

For rigid aircraft, the principle can be transferred to the pitching degree of freedom (measured variable: pitching acceleration, primary manipulated variable: elevator), the yaw degree of freedom (measured variable: yaw acceleration, primary manipulated variable: rudder), lift degree of freedom (measured variable: vertical acceleration n_{z}, primary manipulated variable: flap), longitudinal degree of freedom (measured variable: longitudinal acceleration nₓ, primary manipulated variable: spoiler), as well as transverse degree of freedom (only for lateral force control). The acceleration component is ideally fed back not just to the primary manipulated variable, but to all manipulated variables that influence the respective degree of freedom, for example via the aileron rolling torque, rudder yaw torque, elevator lift or flap pitching torque. The degrees of freedom can be completely decoupled by suitable selection of the amplification matrix. The described degrees of freedom, the acceleration of which is measured, can be chosen as desired. For example, the rotation and translation of the center of gravity is named in aircraft-fixed coordinates. Likewise conceivable are other coordinate systems, as well as other (possibly even several) reference points of the rigid body, for example the vertical position of both wing tips instead of the rolling angle. Any combination of independent degrees of freedom that clearly describes the system is possible. The latter constitutes a valid set of generalized coordinates (q) in the sense of Lagrange formalism.

Based on a schematic illustration of a concept for an acceleration-based control, FIG. 6 shows the transferability of the disclosed control concept to general mechanical systems. The principle can be transferred to any mechanical system 23 with n degrees of freedom, which can be clearly described by generalized coordinates in terms of Lagrange formalism, which is controlled by one or several manipulated variables that exert a direct force or torque influence on the system 23, and the manipulated variables of which are operated by a controlled actuator 24 with at least simple integrating behavior (all mechanical actuators).

Given an actuator position-controlled approach, as opposed to the system according to FIG. 6, the manipulated variable uᵢ has a force influence that can be described by generalized forces Qᵢ=Bᵢⱼ(\dot{q},q)·uᵢ. The same holds true for force or torque disturbances zᵢ with impact factors Eᵢⱼ(\dot{q},q). The acceleration \ddot{q}ᵢ of the generalized coordinate is proportional with Mᵢⱼ⁻¹(q) to the generalized force Qᵢ. Generalized speeds \dot{q} and coordinates q follow through integration. Generalized speeds \dot{q} produce non-conservative “damping forces” D(\dot{q},q)·\dot{q} in dissipative systems. Conservative forces are proportional with C(\dot{q}) to generalized coordinates q. In known control concepts, all states are completely fed back, represented by the generalized coordinates (q) and speeds (\dot{q}). Buildup takes places in the form of a cascade control, wherein the outer control loop relates to generalized coordinates. Their reference variable comprises the target values of the generalized coordinates (q_{c}). The manipulated variable consists of the target values for the generalized speeds (\dot{q}_{c}), which are proportional with the amplification matrix (K_{g}) to the control error q_{c}-q̅. The inner control loop relates to generalized speeds, wherein the reference variable comprises target values for the generalized speeds (\dot{q}_{c}), and the manipulated variable comprises positioning commands (u_{c}), which are proportional to the control error \dot{q}_{c}-\dot{q} with the amplification matrix K_{q}.

The actuator has an arbitrary transfer behavior G(s) between the commanded and actual change in the manipulated variable \dot{u}, but at least one integration stage. Actuator control comprises the feedback of (at least) manipulated variables u, wherein the reference variable is the target value for the system manipulated variables u_{c}. The actuator manipulated variable is the target value for the system positioning rates \dot{u}_{c}, which is proportional to the control error u_{c}-u with amplifications Kᵤ.

By comparison to known controls, the measured, generalized accelerations \ddot{q} are fed back in the acceleration-controlled approach according to FIG. 6 instead of the manipulated variables u proportional thereto. The control command corresponds to the setting rate \dot{u}.

FIG. 7 illustrates a concept for an acceleration-based control of elastic aircraft. FIG. 7 here shows the general case of a complete state feedback. An elastic aircraft constitutes a special case of the disclosed concept explained in connection with FIG. 6, since it can be described by Lagrange formalism. In principle, generalized coordinates can be selected as desired. One possibility involves individual positions of acceleration sensors distributed over the aircraft. The measured acceleration herein corresponds directly to the generalized acceleration \ddot{q}. This requires at least six sensors for acquiring the rigid body movement. The number of additional sensors determines how many elastic modes can be acquired. An alternative option involves a separation of rigid body movement (mean axes) and structural dynamics. Herein, a division takes places into rigid body degrees of freedom (x=[x, y, z, Φ, Θ, Ψ]^{T}) and amplitudes (η=[η₁, η₂, . . . ηₙ]^{T}) of the elastic modes, so that q=[xᵢ, ηᵢ]^{T}. The movement equations for the rigid body movement and structural dynamics are inertially decoupled, but a coupling by way of outside forces (aerodynamics) does exist.

The controlled system comprises the rigid body dynamics (below in FIG. 7), which is built up similarly to the system in FIG. 6, wherein the correlations q=x, B=Bₓ, and E=Eₓ apply. With respect to structural dynamics (above in FIG. 7), the manipulated variable uᵢ has a force influence that can be described by generalized forces Qⱼ.=B_{η, ij}(\dot{q}, q). The same applies to force and torque disturbances (zᵢ) with the impact factors E_{η, ij}(\dot{q}, q). The second derivation of the modal amplitude \ddot{η}ᵢ is proportional to the generalized force Qⱼ with the inverse modal mass matrix μ⁻¹(ij). The structural damping produces damping forces, which are proportional to the rate of change in the modal amplitudes \dot{n}ᵢ with damping factors β. The structural elasticity produces spring forces that are proportional to the modal amplitudes with the generalized rigidity matrix y.

Outside forces produce a coupling between the structure movement and rigid body movement. Herein, the outside forces (aerodynamic forces/torques) depend on rigid body states \dot{x} and \check{x} and structural dynamic states \dot{n} and n. Outside forces influence both the rigid body movement (\ddot{x}) and the structural dynamics (\dot{η}). The portion of the forces on the rigid body movement dependent on rigid body movement was already considered by D, C. The influence of the structural deformation-induced portion of forces on the structural dynamics (Q_{η} and Q_{\dot{η}}) is (by contrast) not already contained in β, y. The dependence of forces on rigid body movement yields an influence on the structural dynamics: Qₓ, Q_{\dot{x}}. The outer control loops relate to the generalized coordinates (q=[xᵢ, ηᵢ]^{T}), the inner control loops to the local degrees of freedom (R_{f}). The system behavior depends on the description form (transformation between various degrees of freedom systems/state illustrations).

A specific case of the concept according to FIG. 7 relates to a local acceleration feedback. Herein, the acceleration is measured directly at the location of the flight control surface. The feedback matrix K_{R} is only diagonally occupied, meaning that the acceleration acts exclusively on the flight control surface where the measurement takes place. The system dynamics can be freely specified, provided the number of setting/measuring positions corresponds to the number of (considered) degrees of freedom (and have been suitably selected, i.e., are linearly independent; this leads to controllability and observability). By contrast, providing a complete eigenstructure is not possible. The system remains coupled. Assuming that the positioning rate command is converted without any delay (disregarding the actuator dynamics), the feedback of acceleration to the positioning rate is equivalent to the feedback of the speed to the actuator position. Assuming that the aerodynamic force generation by the flight control surface takes place without any delay (disregarding transient aerodynamics), a speed-proportional counterforce is generated. The acceleration feedback thus corresponds to a virtual, viscous damper that acts at the location of the flight control surface. Introducing an integrating part or feeding back a local speed measurement would similarly allow introducing a virtual spring element, thereby yielding a more or less rigid clamping of the wing at the location of the flight control surface. Because the damping force always counteracts the direction of movement, an energy supply, and hence a destabilization of the structural dynamic modes is precluded. However, this only applies for as long as the assumptions are justified, i.e., for all structural modes that are clearly lower frequency than the actuator dynamics/transient aerodynamics. This limits the maximum realizable dynamics for acceleration feedback.

By contrast, the risk of an excitation exists in an acceleration measurement that is locally separate from the flight control surface (e.g., IMU in the cockpit), since the acceleration signal only reacts to the force generated on the flight control surface after a delay caused by the structural dynamics. Expressed differently, an eigenform can possibly exist the vibration antinode of which, at the measurement location, has an opposite sign compared to the location of the force generation (flight control surface). A negative, destabilizing damping force thus arises in the frequency range of this eigenmode. This is precluded if the measurement takes place directly at the location of force generation.

In classic flight control, the bandwidth limitation arises from the frequency separation to the structural dynamics. By contrast, a bandwidth limitation arises for the local acceleration feedback from the frequency separation to transient aerodynamics and actuator dynamics.

In particular, advantages of the acceleration-controlled concept can lie in the achievability of a higher dynamic for flight control, and hence improved interference suppression, flight silence and higher agility, especially in the case of highly elastic aircraft, wherein no frequency separation to the structural dynamics or filtering of elastic modes is required. An automatic damping of all elastic modes below the actuator dynamics and in particular the aerodynamics can be enabled, independently of the concrete elastic properties of the aircraft. Interference influences (local gusts) are balanced out directly at the attack site, without exciting the structural dynamics (similar to a bird that only locally spreads feathers to yield to a gust). Structural loads are reduced. The acceleration measurement and control can be integrated into an actuator control (smart actuator). This enables a decentralized system structure. The acceleration-regulated concept permits new redundancy concepts and allows a simple adaption of control laws in the event of a flight control surface failure. Given a sufficient frequency separation between the acceleration control (decentralized in the actuator) and position control (centrally in the FCC), the position control and all higher-level control loops can remain unchanged, since the reduced dynamics of acceleration control are still fast enough. This reflects the fact that, in classic flight control, the failure of a redundant actuator for the same flight control surface as a rule requires no adaption of the FCL.

FIGS. 8A to 8E show the overall system dynamics in the complex plane of an exemplary embodiment of the arrangement, which can arise from transferring the structure illustrated in FIG. 5 to the pitch degree of freedom. FIG. 8B here shows a magnified cutout of FIG. 8A, FIG. 8C a magnified section of FIG. 8B, FIG. 8D a magnified section of FIG. 8C, and FIG. 8E a magnified section of FIG. 8D. The illustration in FIGS. 8A to 8E is based upon a device for controlling the elevator as per the present disclosure. The longitudinal position θ and pitch rate q are fed back. The pole and zero position distribution is shown, which for the depicted embodiment arises for various feedback amplifications (+-shaped markings). Also shown for comparison is the pole and zero position distribution that arises for a previously known control, in which the adjustment angle of the elevator is controlled by the actuating system control (x-shaped markings). The magnified x- or +-markings denote the pole positions that arise when both feedback amplifications (for q and θ) assume the value zero. For the previously known control (x), this pole distribution corresponds to a pattern known for uncontrolled aircraft, in which one conjugated complex pole pair is to be allocated to the phygoid movement and another to the angle of attack vibration. Feeding back the local acceleration within the framework of the disclosed embodiment, the angle of attack vibration is strongly dampened and split into two real poles. By contrast, this has hardly any influence on the phygoid poles.

The depicted smaller markings connected by lines denote pole positions that can arise given a simultaneous increase in feedback amplifications for the pitch rate and longitudinal position in a constant ratio. The star-shaped markings denote pole positions that can arise for an advantageous selection of feedback amplifications when a high bandwidth for the control circuit is desired at a damping level that does not drop below the value 0.7.

FIG. 9 shows a Bode diagram for a previously known 25 and for the disclosed 26 embodiment according to FIGS. 8A to 8E, which can arise for a respectively advantageous selection of feedback amplifications. Shown is the frequency response of an interference transmission function of the vertical wind speed w_{Wg} (gust) on the longitudinal position θ. In a frequency range below the dynamic of the actuating system control, the disclosed embodiment 26 (solid line) reveals an improved interference behavior, since the transmission function of the previously known arrangement 25 (broken line) has an additional zero point, which nearly compensates for the pole associated with the position control loop of the servocontrol. This zero point is eliminated by the acceleration feedback.

FIG. 10 illustrates an exemplary embodiment for a flexible aircraft. Without placing any limitation on generality, the view in FIG. 11 is herein limited to the flexibility of the main wing in relation to a bending around the longitudinal axis, a torsion around the transverse axis, as well as the resultant local vertical movements. In addition to the six degrees of freedom of a rigid body, a flexible aircraft has additional degrees of freedom, which describe the deformation state. Apart from the rigid body degrees of freedom of an undeformed reference configuration 27, a conventional presentation form comprises the amplitudes of superposed eigenforms of the elastic modes, which describe characteristic deformation patterns as compared to the reference configuration. Such an eigenform is exemplarily depicted in FIG. 10. Herein, the eigenform can have local extreme points 28, at which the deviations from the reference configuration are greatest, and node points 29, at which the deviations from the reference configuration disappear. In order to control and stabilize the deformation degrees of freedom, a flexible aircraft can have several actuating systems (flight control surface assemblies), which can be comprised of flight control surfaces 30 and possibly fins 31. A device according to the present disclosure can use one or several actual accelerations at any points 32 of the aircraft for control purposes. In an advantageous embodiment, for example, these can be extreme points or node points of one or several eigenforms, but also points at which none of the eigenforms relevant for control purposes has a node point. In particular, the number of used accelerations can correspond to a number of eigenvalues that are to be stabilized or influenced by the control. For example, all accelerations can herein be received by each of the provided devices. Alternatively, a device can only receive those accelerations that can be influenced by an adjustment of the actuating system controlled by the device.

Shown in FIG. 11 is a design of an arrangement for a flexible aircraft, in which the points 32 of the aircraft where the local acceleration is used for controlling the actuating systems lie in proximity to the flight control surfaces 30. For example, all accelerations can herein once again be received by all disclosed devices. Alternatively, each device can receive only the respective acceleration that is present in proximity to the actuating system controlled by this device.

The features disclosed in the above specification, the claims and the drawing can be important both individually and in any combination for implementing the different embodiments.

1. A device for control and closed-loop control of an actuating system of an aircraft, comprising
a first input interface, which is configured to receive first input data indicating a reference variable;
a second input interface, which is configured to receive second input data indicating a controlled variable; and
a control output, which is configured to output a control signal that indicates a manipulated variable for an actuating system of an aircraft, which is to be controlled by means of the actuating system,
wherein
the reference variable indicates a target acceleration at a point of the aircraft that is to be controlled by means of the actuating system;
the controlled variable indicates an actual acceleration of the aircraft at the point; and,
taking into account the reference variable and the controlled variable, the device is configured to determine the manipulated variable, preferably from the difference between the reference variable and the controlled variable, and to output the control signal corresponding to the manipulated variable via the control output.

2. The device according to claim 1, comprising a third input interface, which is configured to receive third input data indicating an actuating system controlled variable, wherein the device is configured
to determine an actuating system reference variable taking into account the reference variable and the controlled variable, and
to determine the manipulated variable taking into account the actuating system reference variable and the actuating system controlled variable.

3. The device according to claim 2, wherein the actuating system reference variable is a target positioning speed of the actuating system, and the actuating system controlled variable is an actual positioning speed of the actuating system.

4. The device according to claim 1, wherein the device is configured to determine the manipulated variable without considering an actual actuator position of the actuating system, and without determining a target actuator position of the actuating system.

5. The device according to claim 1, comprising an additional input interface, which is configured to receive additional input data indicating an additional controlled variable, wherein
the additional controlled variable indicates an actual acceleration of the aircraft at an additional point; and
the device is configured to adjust the controlled variable taking into account the additional controlled variable, and subsequently determine the manipulated variable taking into account the reference variable and the controlled variable.

6. An arrangement for control and closed-loop control of an actuating system of an aircraft, comprising
an aircraft, having
an actuating system, which is configured to control the aircraft in at least one degree of freedom, and
an acceleration sensor, which is arranged at one point of the aircraft;
a flight control device with an output interface; and
a device according to one of the preceding claims,
wherein
the flight control device is configured to calculate the reference variable indicating a target acceleration at the point of the aircraft from a flight status of the aircraft, and transmit the first input data indicating the reference variable to the first input interface of the device via the output interface;
the acceleration sensor is configured to measure the local acceleration of the aircraft at the point, and transmit second input data indicating the controlled variable to the second input interface of the device, which indicate the local acceleration at the point; and
the actuating system is configured to receive the manipulated variable from the control output of the device, and perform a positioning movement corresponding to the manipulated variable.

7. The arrangement according to claim 6, wherein the flight control device is configured to calculate the reference variable taking into account a actuating variable determined in a directly kinematic manner from a target trajectory of the aircraft.

8. The arrangement according to claim 6, wherein the actuating system is formed with an actuator that moves a flight control surface of a flight control surface assembly of the aircraft.

9. The arrangement according to claim 8, wherein the acceleration sensor is arranged on a part of the flight control surface assembly that is immovable relative to the aircraft.

10. The arrangement according to claim 6, comprising an additional acceleration sensor, which is arranged at an additional point of the aircraft, wherein
the device is a device according to claim 5; and
the additional acceleration sensor is configured to measure the local acceleration at the additional point, and transmit the additional input data indicating the additional controlled variable to the additional input interface of the device, which indicate the local acceleration at the additional point.

11. The arrangement according to claim 1, wherein the aircraft has an additional actuating system, which is configured to control the aircraft in the at least one degree of freedom or in at least one additional degree of freedom, and has an additional acceleration sensor, which is arranged at an additional point of the aircraft, wherein
the flight control device is configured to also transmit the input data indicating the reference variable to the additional device via the output interface;
the additional acceleration sensor is configured to measure the local acceleration of the aircraft at the additional point, and transmit second input data indicating an additional controlled variable to the additional device, which indicate the local acceleration at the additional point; and
the additional actuating system is configured to receive the manipulated variable from the control output of the additional device, and perform a positioning movement corresponding to this manipulated variable.

12. The arrangement according to claim 6, wherein the aircraft is a highly flexible aircraft.

13. A method for control and closed-loop control of an actuating system of an aircraft, with the steps of
providing a device for control and closed-loop control of an actuating system of an aircraft;
generating first input data indicating a reference variable, wherein the reference variable indicates a target acceleration at a point of the vehicle that is to be controlled by means of the actuating system;
generating second input data indicating a controlled variable, wherein the controlled variable indicates an actual acceleration of the vehicle at the point;
receiving the first input data at a first input interface of the device;
receiving the second input data at a second input interface of the device;
determining a manipulated variable for an actuating system of the aircraft taking into account the reference variable and the controlled variable, preferably from the difference between the reference value and the controlled variable; and
outputting a control signal indicating the manipulated variable via a control output of the device.

14. The method according to claim 13, comprising receiving third input data that indicate an actuating system controlled variable at a third input interface of the device, wherein determining the manipulated variable taking into account the reference variable and the controlled variable comprises determining an actuating system reference variable taking into account the reference variable and the controlled variable, and determining the manipulated variable taking into account the actuating system reference variable and the actuating system controlled variable.
